(19) United States
(12) Patent Application Publication
(10) Pub. No.: US 2014/0031158 A1
(43) Pub. Date: Jan. 30, 2014

(54) PLANETARY HYBRID TRANSMISSION

(71) Applicant: Schaeffler Techologies AG & Co. KG, Herzogenaurach (DE)

(72) Inventors: Jeffrey Hemphill, Copley, OH (US); Edmund Maucher, Jeromesville, OH (US)

(73) Assignee: Schaeffler Techologies AG & Co. KG, Herzogenaurach (DE)

(21) Appl. No.: 13/953,407

(22) Filed: Jul. 29, 2013

Related U.S. Application Data
(60) Provisional application No. 61/677,145, filed on Jul. 30, 2012.

(51) Int. Cl. B60W 20/00

(52) U.S. Cl. CPC B60W 20/10; Y10S 903/902
USPC 475/5; 180/65.22; 903/902

(57) ABSTRACT

The present invention is an automatic transmission equipped with at least one planetary gear set and including a single electric motor/generator having a motor output shaft; a hydrocarbon fueled engine; at least one transmission input shaft; an engine clutch operatively attached to the hydrocarbon fueled engine to the at least one transmission input shaft; a motor/generator clutch; a plurality of transmission clutches; and, a plurality of transmission clutch brakes.

### CROSS-REFERENCE TO RELATED APPLICATIONS

This applications claims the benefit under 35 U.S.C.§119(e) of U.S. Provisional Application No. 61/677,145, filed Jul. 30, 2012, which application is incorporated herein by reference.

### FIELD OF THE INVENTION

The present invention relates to automatic transmissions for motor vehicles, specifically for automatic transmissions for electric-gasoline hybrid engines (“hybrids” or “hybrid engines”) and more specifically for automatic transmissions adapted for hybrid engines.

### BACKGROUND OF THE INVENTION

Electric-gasoline hybrid vehicles usually need unique drivetrains and transmissions to obtain maximum efficiency from that type of engine. Typical hybrid drivetrains are either “starter/alternator” drivetrains or unique drivetrains manufactured for a one or a few specific vehicle models. The disadvantage of a starter/alternator drivetrain is that it cannot be operated in an “electric only” mode in which the electric motor alone drives the car. Thus the gasoline engine is always engaged with the drivetrain during braking and energy recovery mode.

The primary drawback of unique hybrid drivetrains, such as found in the Toyota Prius is its expense. These drivetrains require unique transmissions and two distinct electric motors.

Thus, there is a need in the field for a transmission that is inexpensive, that is operable with a single electric motor, possesses an operation mode in which the electric motor is engaged with the drivetrain during braking and energy recovery mode and can be operated only with the electric motor.

### SUMMARY OF THE INVENTION

The present invention broadly comprises an automatic transmission for a hybrid motor vehicle having at least one planetary gear set and comprising a single electric motor/generator having a motor output shaft; a combustion (hydrocarbon fueled) engine; a first one transmission input shaft; a lockup (engine) clutch wherein the engine clutch operatively attaches the combustion engine to the first engine transmission input shaft; a motor/generator clutch; a plurality of transmission clutches; and, a plurality of transmission clutch brakes.

In at least one embodiment, the motor clutch is a dog clutch.

In an alternate embodiment, the motor clutch is a friction clutch.

In a second alternate embodiment, the engine clutch is replaced by a torque converter.

In various embodiments, the combustion engine may be fueled by gasoline, diesel fuel, and/or natural gas.

One object of the invention is to modify existing automatic transmissions to include a hybrid transmission capability with a single electric motor.

A second object of the invention is to supply a less expensive hybrid transmission.

A third object of the invention is to provide hybrid transmissions that possess different modes of operation.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a schematic cross section view of an automatic transmission before modification;

FIG. 2 is a schematic representation of a modification of the automatic transmission in which an electric motor is functionally connected to the planetary gear set using a dog clutch;

FIG. 2A demonstrates schematically the different engagement modes among the motor output shaft, the engine transmission input shaft, and the motor transmission input shaft;

FIG. 3 schematically depicts a second modification of the automatic transmission in which only friction clutches are used as engine and motor clutches;

FIG. 4 schematically depicts a modification of the automatic transmission in which a torque converter replaces the engine clutch in making the connection of the engine to the transmission;

FIG. 4A demonstrates schematically the different engagement modes among the motor output shaft, the engine transmission input shaft, and the motor transmission input shaft; and,

FIG. 5 is a table showing the engagement pattern of the one way clutch and each of the clutches and clutch brakes while the modified automatic transmission is in various drive gears.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

The present invention is directed to modifications of an automatic transmission for a motor vehicle in is equipped with at least one planetary gear system. The modifications add a hybrid functionality to the transmission by adding an electric motor or preferably a motor/generator and accompanying inputs to the transmission.

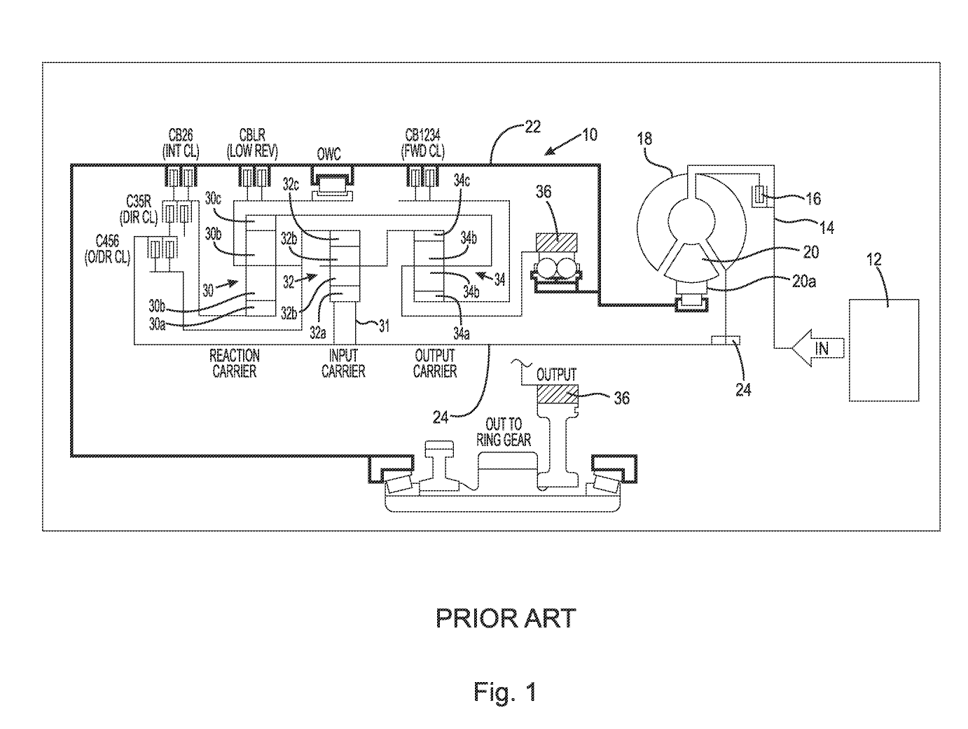

Adverting to the drawings, FIG. 1 is a schematic cross section view of an automatic transmission 10 (“transmission 10”) before modification. Transmission 10 includes three planetary gear sets 30, 32, and 34. Lockup clutch 16 operatively attaches combustion engine 12 (“engine 12”) to torque converter 18. By functional attachment is meant that lockup clutch 16 directly or indirectly links engine 12 with torque converter 18 and allows the turbine of torque converter 18 to directly transmit torque to transmission input shaft 24 by bypassing the fluid coupling of created by torque converter 18. Stator 20 connects to transmission case 22 through one-way clutch 20a. The bold line in in FIG. 1 schematically represents the nonrotating components of transmission 10 such as transmission case 22 and clutch brakes. Each of the planetary gears 30, 32, and 34 contains sun gears 30a, 32a, and 34a, planet gear sets 30b, 32b, and 34b, and ring gears 30c, 32c, and 34c respectively, along with respective carriers.

The gear sets 30, 32, and 34 are connected to transmission clutches (Cxxx) and transmission clutch brakes (CBxxx) to connect and brake the various planetary gear elements to transmit torque from input shaft 24 to output gear 36. The clutches and brakes engage and disengage as different drive gears are operated as explained below.

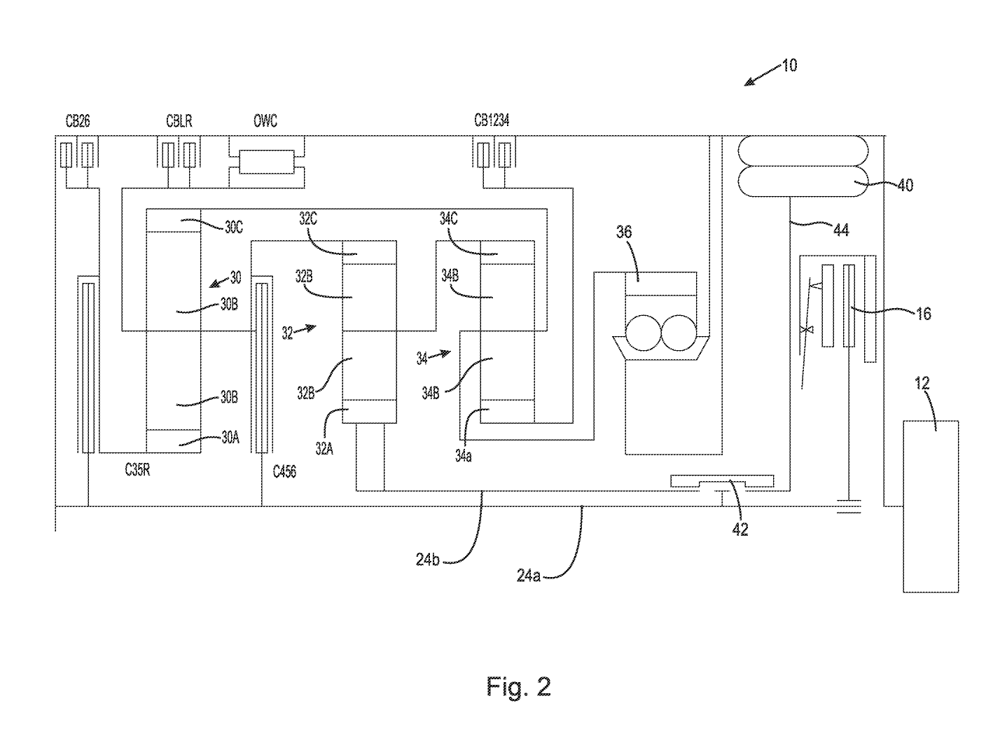

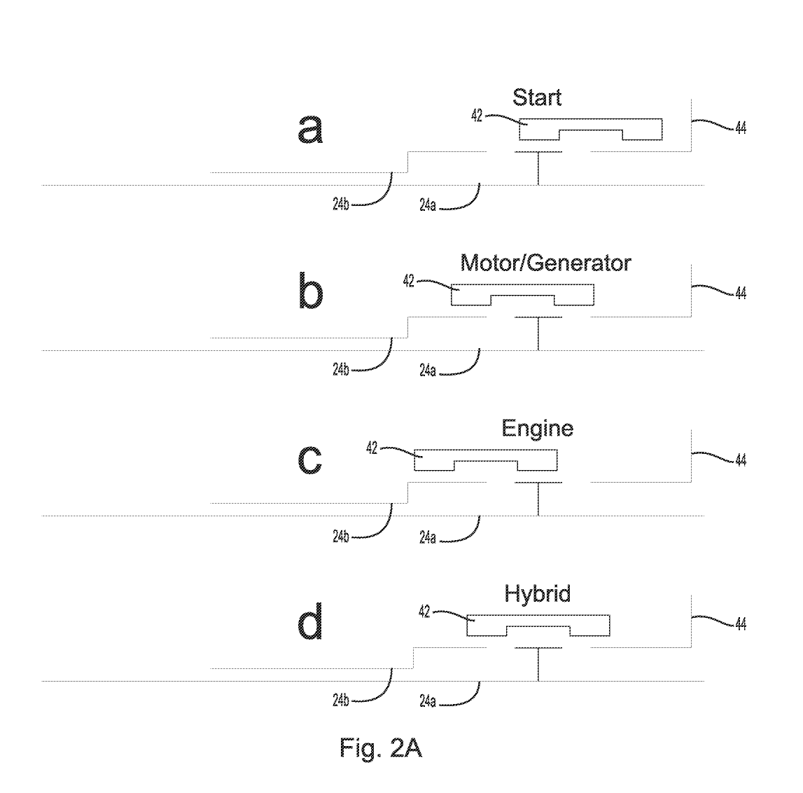

FIG. 2 is a schematic representation of a modification of transmission 10 above in which a an electric motor/generator 40 is selectively connected to the planetary gear set using a motor clutch 42. Motor clutch 42 may be a dog clutch that allows transmission 10 to be operated in several different modes. There is no torque converter in this modification.

FIG. 2A demonstrates schematically the different engagement combinations among motor shaft 44, engine transmission input shaft 24a, and motor transmission input shaft 24b. Mode a is the start mode in which motor clutch 42 connects motor shaft 44 with engine transmission input shaft 24a. In mode a, combustion engine 12 can be started when clutches C35R and C456 are disengaged and engine clutch 16 is engaged. By engaged or engagement is meant that engine clutch 16 and motor clutch 42 operatively attach selected components to transmit drive power. By disengaged is meant that those clutches are not connecting components. By operatively attached is meant that a component or device is connected either directly or indirectly to a second component and causes that second component to function. For example, as described above, engine clutch 16 when engaged operatively attaches or operationally attaches engine 12 to transmission input shaft 24 meaning the clutch engagement causes drive power to be transmitted from engine 12 to engine transmission input shaft 24a. These definitions also apply to transmission clutches and clutch brakes. It can be seen that transmission input shaft 24a is operatively attached to at least one of the transmission clutches, in this case clutches C35R and C456.

In mode b, motor/generator mode, motor clutch 42 is arranged to engage motor shaft 44 with engine transmission input shaft 24a and also engage a second transmission input shaft, motor transmission input shaft 24b which is functionally attached to sun gear 32a. When engine clutch 16 is disengaged only motor 40 provides torque to transmission 10 for an electric drive mode. When motor clutch 42 is in the same position and engine clutch 16 is engaged (i.e., when battery power is low), the main driving power is provided by engine 12 and motor/generator 40 can boost the gasoline engine, recover braking and coasting energy and charge the battery (not shown). By functional attachment is meant that the attachment between motor transmission input shaft 24b and sun gear 32a allows drive power to be supplied to sun gear 32a enabling sun gear 32a to function. Engine clutch 16 may be selectively disengaged to increase efficiency of energy recovery from braking and coasting.

In engine drive mode c, motor clutch 42 connects the two transmission input shafts 24a and 24b with motor shaft 44 disengaged. In this mode, only engine 12 provides driving power to transmission 10 and no energy recovery is made from braking or coasting. The transmission operates as a conventional transmission in this mode, which may be useful as a towing mode or as a ‘limp home’ mode after a failure of the motor, batteries, or electric controls, for example.

Mode d is the hybrid drive mode in the modification shown in FIGS. 2 and 2A. In this mode, motor clutch 42 connects motor shaft 44 with motor transmission output shaft 24b, and engine transmission input shaft 24a is engaged by engine clutch 16 with engine 12. In first and second drive gears, motor/generator 40 alone drives the vehicle while in the higher gears, the transmission is operated in infinite variable transmission mode (IVT) mode. That is, some power is provided by engine 12 and some power is provided by motor/generator 40. Motor/generator 40 provides the control function for the transmission ratio and resulting power split, and either boosts engine power or generates electricity.

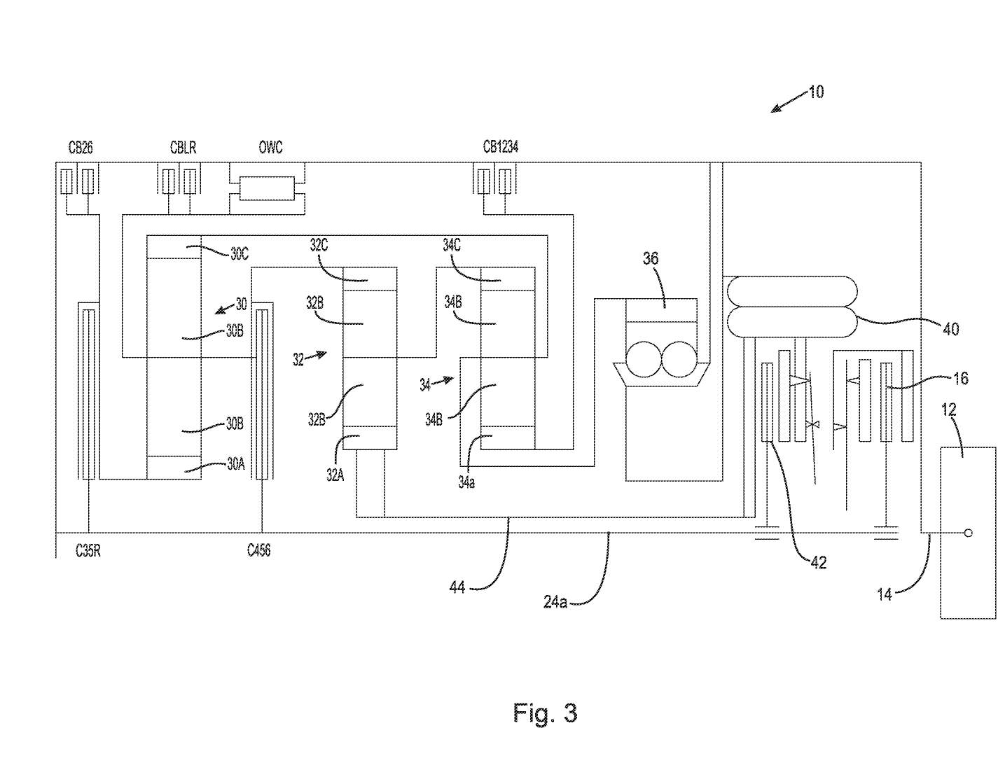

FIG. 3 schematically depicts a second modification of transmission 10. In this modification, friction clutches are used for the motor clutch 42 and engine clutch 16. All of the operating modes are the same as described above except there is no engine only driving mode. Engine clutch 16 connects transmission input shaft 24a with engine 12 and motor clutch 42 is arranged to selectively or optionally connect transmission input shaft 24a with motor/generator 40. By selectively or optionally select is meant that engine clutch 16 and/or motor clutch 42 is engaged or disengaged with various input and/or output shafts under the direction of a user or computer. In start engine mode, both clutches 16 and 42 are engaged and all the transmission clutches C and transmission clutch brakes CB are disengaged. In the electric mode, motor clutch 42 is engaged and engine clutch 16 is disengaged so that only motor/generator 40 drives transmission 10. In motor/generator mode, both motor clutch 42 and engine clutch 16 are simultaneously engaged so that motor 40 can boost engine 12 through engagement with transmission input shaft 24a and recover energy during braking and coasting. In hybrid mode, motor clutch 42 is disengaged and engine clutch 16 is engaged. It can be seen from FIG. 3 that motor shaft 44 is directly connected to planetary gear set 32 to provide power to transmission 10 in low gears (i.e., gears 1 and 2) before engine 12 drives transmission 10 through clutches C35R and C456 and transmission input shaft 24a in effect acting as a second transmission input shaft.

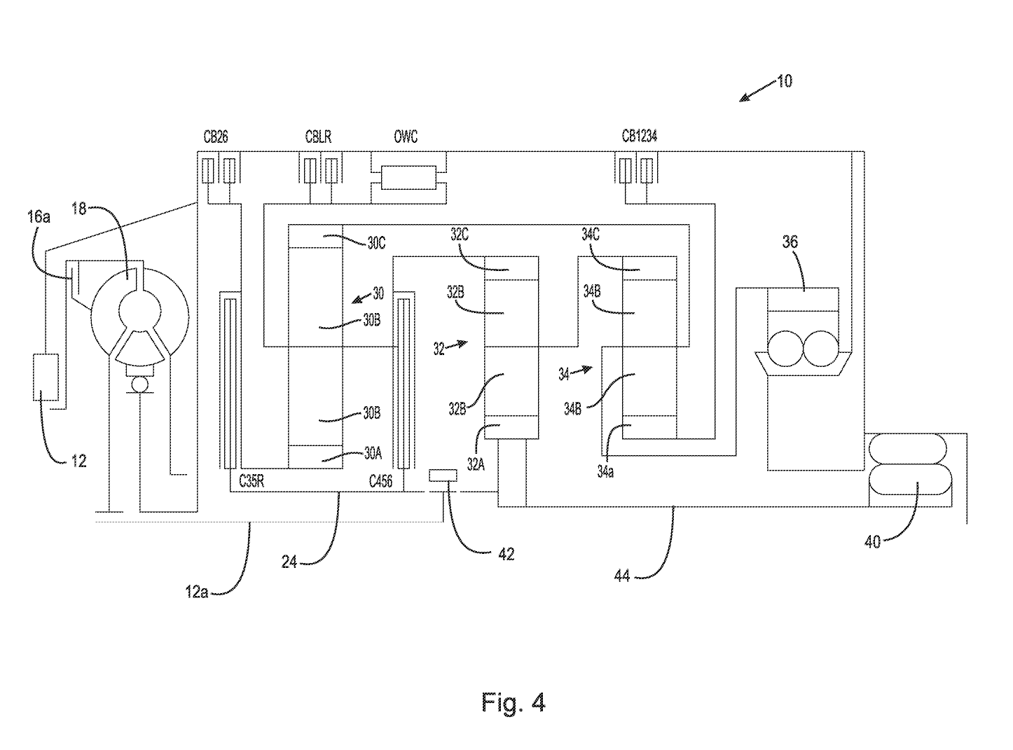

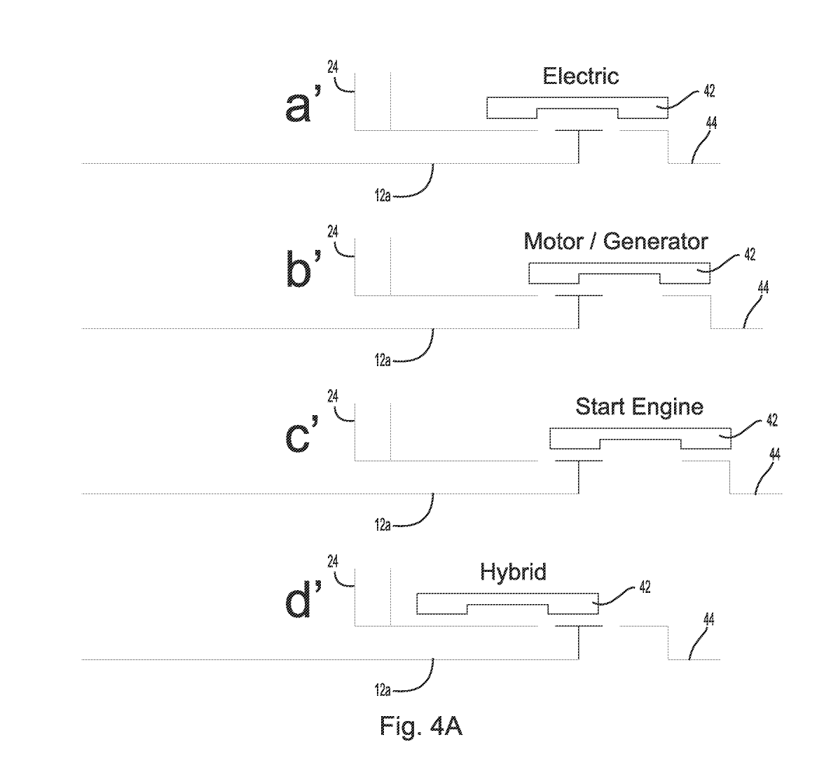

FIG. 4 schematically depicts a modification of transmission 10 in which torque converter 18 replaces the engine clutch in making the connection of engine 12 to the drivetrain. Clutch 16a is a lockup clutch for bypassing the fluid circuit in a known manner. As in the modification discussed above, this modification does not allow for an engine only drive mode.

FIG. 4A demonstrates schematically the different engagement modes among the motor shaft, the torque converter shaft, and the motor transmission input shaft. Motor clutch 42 may be a claw clutch, or dog clutch, that connects torque converter shaft 12a and/or motor shaft 44 with transmission input shaft 24. In electric only mode a′, motor clutch 42 connects transmission input shaft 24 with motor shaft 44. In motor/generator mode b′, motor clutch 42 is engaged with both motor shaft 44 and torque converter output shaft 12a and connects them with transmission input shaft 24. Similar to the motor/generator mode discussed above, mode b′ enables motor/generator 40 through motor shaft 44 to power transmission 10 in the lower gears with torque converter clutch 16a disengaged and to recover energy during braking and coasting in the higher gears. In effect, motor shaft 44 acts as a second transmission input shaft.

In start engine mode c′, motor clutch 42 connects engine 12 and torque converter 18 with motor/generator 40 through torque converter output shaft 12a and motor shaft 44. In mode c′, lockup clutch 16a is engaged. In hybrid mode d′, motor clutch 42 connects transmission input shaft 24 with torque converter output shaft 12a while motor shaft 44 is connected with input gear set 32. In the hybrid mode d′, motor 40 inputs power to gear set 32, preferably sun gear 32a to power transmission 10 in the lower gears with engine 12 powering transmission 10 through torque converter 18 and torque converter output shaft 12a to gear set 30 preferably using an infinite variable transmission system.

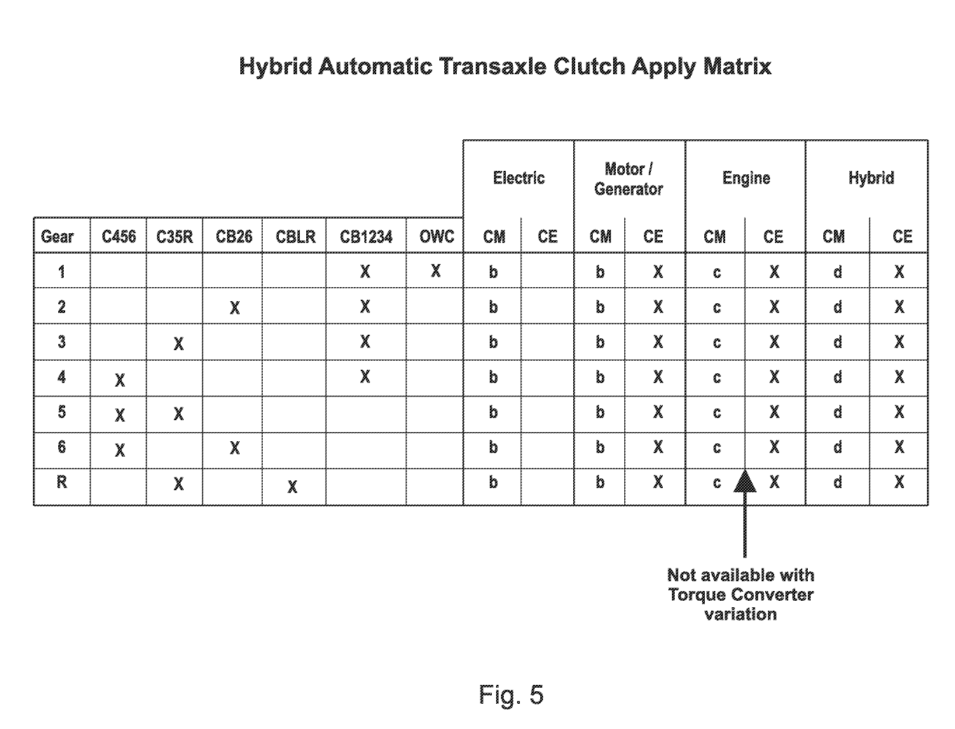

In all the modifications described above, transmission 10 includes clutches (Cxxx) and clutch brakes (CBxxx) in line with the output from gear sets 30, 32, and 34. Also seen in is one way clutch OWC. FIG. 5 is a table showing the engagement pattern of the one way clutch and each of the clutches and clutch brakes while transmission 10 is in various drive gears. Clutch brakes act to lock a gear to prevent its rotation. In a one embodiment, the clutch brake will lock the gear against the transmission case to prevent it from rotating. For instance, in drive gears 1-4, clutch brake 1234 locks sun gear 34a through the first four forward drive gears while clutch OWC engages gear set 32. FIG. 5 also presents the engagement mode for the motor clutch and whether the engine clutch is engaged for each of the different driving modes discussed above.

The motor clutches can be controlled and moved into the various mode positions discussed above using hydraulic systems as in automatic transmissions or by using electronic actuators. These systems can be controlled by the on board vehicle computer.

Thus it is seen that the objects of the invention are efficiently obtained, although changes and modifications to the invention should be readily apparent to those having ordinary skill in the art, which changes would not depart from the spirit and scope of the invention as claimed.

1. An automatic transmission for a hybrid motor vehicle having a plurality of planetary gear sets and comprising:
a single electric motor/generator having a motor shaft,
a combustion engine;
a first transmission input shaft;
an engine clutch, wherein said engine clutch operatively attaches said combustion engine and said first transmission input shaft when engaged;
a motor/generator clutch;
a plurality of transmission clutches; and,
a plurality of transmission clutch brakes.

2. The automatic transmission as recited in claim 1 wherein said first transmission input shaft is operatively attached to at least one of said plurality of transmission clutches.

3. The automatic transmission as recited in claim 2 further comprising a second transmission input shaft and wherein said second transmission input shaft is functionally attached to a sun gear of a second one of said plurality of planetary gear sets.

4. The automatic transmission as recited in claim 3 wherein said motor clutch is arranged to operatively attach said second transmission input shaft to said motor shaft.

5. The automatic transmission as recited in claim 3 said motor clutch is arranged to simultaneously operatively attach said first transmission input shaft and said second transmission input shaft to said motor shaft.

6. The automatic transmission as recited in claim 3 wherein said motor/generator clutch is arranged to simultaneously engage said second transmission input shaft and said first transmission input shaft.

7. The automatic transmission as recited in claim 4 further comprising an infinite variable transmission system and wherein said motor clutch is arranged to connect said motor shaft with said second transmission input shaft.

8. The automatic transmission as recited in claim 2 wherein said motor shaft is functionally attached to a sun gear of a second one of said plurality of planetary gear sets.

9. The automatic transmission as recited in claim 8 wherein each of said motor clutch and said engine clutch is arranged to be optionally engaged with said first transmission input shaft.

10. The automatic transmission as recited in claim 9 further comprising an infinite variable transmission system and wherein both of said motor clutch and said engine clutch are arranged to simultaneously engage with said first transmission input shaft.

11. The automatic transmission as recited in claim 2 wherein said engine clutch is replaced by a torque converter and a torque converter output shaft and wherein said motor shaft is functionally attached to a sun gear of a second one of said plurality of planetary gear sets and optionally engaged with said motor clutch.

12. The automatic transmission as recited in claim 11 wherein motor clutch is arranged to optionally engage each of said torque converter output shaft and said motor shaft with said first transmission input shaft.

13. The automatic transmission as recited in claim 11 wherein said motor clutch is arranged to simultaneously engage said first transmission input shaft with said motor shaft and said torque converter output shaft.

14. The automatic transmission as recited in claim 11 further comprising an infinite variable transmission system.

15. The automatic transmission as recited in claim 1 wherein said motor clutch is a dog clutch.
